(19) United States
(12) Patent Application Publication
(10) Pub. No.: US 2007/0263010 A1
(43) Pub. Date: Nov. 15, 2007

(54) Large-scale visualization techniques

(75) Inventors: Nagalinga Durga Prasad Sripathi Panditharadhya, Redmond, WA (US); John Edward Churchill, Monroe, WA (US); Jordan Conrad Sehn, Redmond, WA (US); Udaya Kumar Bhaskara, Redmond, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/434,390

(22) Filed: May 15, 2006

(51) Int. Cl. G09G 5/00

(52) U.S. Cl. 345/619

(57) ABSTRACT

Various technologies and techniques are disclosed that enhance a user's interaction with components on a design surface. A search feature allows the user to search components on the design surface based on specified search criteria. The system searches the components on the design surface to determine if any components meet the search criteria. The system visually indicates which components on the design surface meet the specified search criteria. A preview pane provides the user with a high level view of the various components on the design surface, including search results that meet specified criteria. The user can collapse the original preview pane, and upon doing so, the system displays a scroll bar with at least one indicator to provide a mini-preview of any search results in a smaller area than the original preview pane. A navigation feature allows the user to navigate the design surface.

### BACKGROUND

There are numerous types of visual designers on the market today that allow users to create sophisticated diagrams, business process integrations, user interfaces, and so on. These visual designers allow users to drag and drop components onto a design surface and to create both small-scale and large-scale designs. The larger the diagram becomes, the more difficult it becomes for the user to interact with and navigate. For example, when a diagram flows onto multiple pages, it can be very tedious for the user to scroll through every page of the diagram to see whether particular components or types of components are present. The diagram itself also becomes harder to navigate, involving lots of scrolling and/or viewing in ways that makes it harder to read. Furthermore, the user working with a large diagram may only be concerned with a particular portion of the diagram at a given moment. The diagram, however, may display a lot of unnecessary components that are really just in the way of what the user is trying to accomplish.

### SUMMARY

Various technologies and techniques are disclosed that enhance a user's interaction with components on a design surface. A search feature allows the user to search components on the design surface based on specified search criteria. The system searches the components on the design surface to determine if any components meet the search criteria. The system visually indicates which components on the design surface meet the specified search criteria. A preview pane provides the user with a high level view of the various components on the design surface, including search results that meet specified criteria. The user can collapse the original preview pane, and upon doing so, the system displays a scroll bar with at least one indicator to provide a mini-preview of any search results. The scroll bar is displayed in a smaller area than the original preview pane. A navigation feature allows the user to navigate the design surface using one or more navigation techniques.

This Summary was provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a diagrammatic view of a computer system of one implementation.

FIG. 2 is a diagrammatic view of a visual designer application of one implementation operating on the computer system of FIG. 1.

FIG. 3 is a high-level process flow diagram for one implementation of the system of FIG. 1.

FIG. 4 is a process flow diagram for one implementation of the system of FIG. 1 illustrating the stages involved in providing a search feature to locate certain components/shapes.

FIG. 5 is a process flow diagram for one implementation of the system of FIG. 1 illustrating the stages involved in providing a collapsed preview pane to allow search results to be displayed in a smaller area.

FIG. 6 is a process flow diagram for one implementation of the system of FIG. 1 illustrating the stages involved in collapsing areas on the design surface.

FIG. 7 is a process flow diagram for one implementation of the system of FIG. 1 that illustrates the stages involved in using an artifact explorer area to manage components/shapes on the design surface.

FIG. 8 is a process flow diagram for one implementation of the system of FIG. 1 that illustrates the stages involved in highlighting selected relationships on the design surface.

FIG. 9 is a process flow diagram for one implementation of the system of FIG. 1 that illustrates the stages involved in highlighting areas for drag drop operation.

FIG. 10 is a process flow diagram for one implementation of the system of FIG. 1 that illustrates the stages involved in drilling down on a particular component/shape.

FIG. 11 is a process flow diagram for one implementation of the system of FIG. 1 that illustrates the stages involved in automatically scaling components/shapes on the design surface.

FIG. 12 is a simulated screen for one implementation of the system of FIG. 1 that illustrates an overview of a visual designer with parts of a large-scale diagram displayed.

FIG. 13 is a simulated screen for one implementation of the system of FIG. 1 that illustrates a search technique with a preview window.

FIG. 14 is a simulated screen for one implementation of the system of FIG. 1 that illustrates a search technique with a mini-preview window.

FIG. 15 is a simulated screen for one implementation of the system of FIG. 1 that illustrates a search technique with collapsed relationship sets.

FIG. 16 is a simulated screen for one implementation of the system of FIG. 1 that illustrates an interaction between an artifact explorer and a main drawing surface.

FIG. 17 is a simulated screen for one implementation of the system of FIG. 1 that illustrates highlighting related components/shapes.

FIG. 18 is a simulated screen for one implementation of the system of FIG. 1 that illustrates drilling down on a shape/component.

FIG. 19 is a simulated screen for one implementation of the system of FIG. 1 that illustrates an auto-scaling feature after one shape/component is added to a design surface.

FIG. 20 is a simulated screen for one implementation of the system of FIG. 1 that illustrates an auto-scaling feature after more shapes/components are added to the design surface of the simulated screen of FIG. 19.

### DETAILED DESCRIPTION

For the purposes of promoting an understanding of the principles of the invention, reference will now be made to the embodiments illustrated in the drawings and specific language will be used to describe the same. It will nevertheless be understood that no limitation of the scope is thereby intended. Any alterations and further modifications in the described embodiments, and any further applications of the principles as described herein are contemplated as would normally occur to one skilled in the art.

The system may be described in the general context as an application that provides one or more visualization techniques, but the system also serves other purposes in addition to these. In one implementation, one or more of the techniques described herein can be implemented as features within a process integration program such as MICROSOFT® BizTalk, MICROSOFT® Office VISIO®, or from any other type of program or service that works with business processes, diagrams, or other visual designs. In another implementation, one or more of the techniques described herein are implemented as features with other applications that deal with components, clauses, and/or shapes drawn on a design surface.

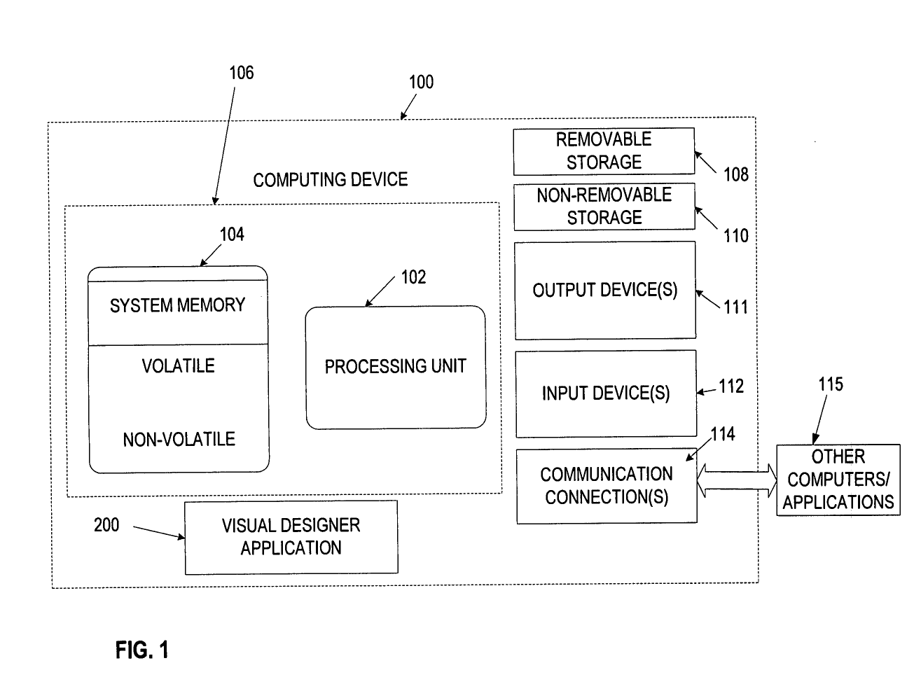

As shown in FIG. 1, an exemplary computer system to use for implementing one or more parts of the system includes a computing device, such as computing device 100. In its most basic configuration, computing device 100 typically includes at least one processing unit 102 and memory 104. Depending on the exact configuration and type of computing device, memory 104 may be volatile (such as RAM), non-volatile (such as ROM, flash memory, etc.) or some combination of the two. This most basic configuration is illustrated in FIG. 1 by dashed line 106.

Additionally, device 100 may also have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by device 100. Any such computer storage media may be part of device 100.

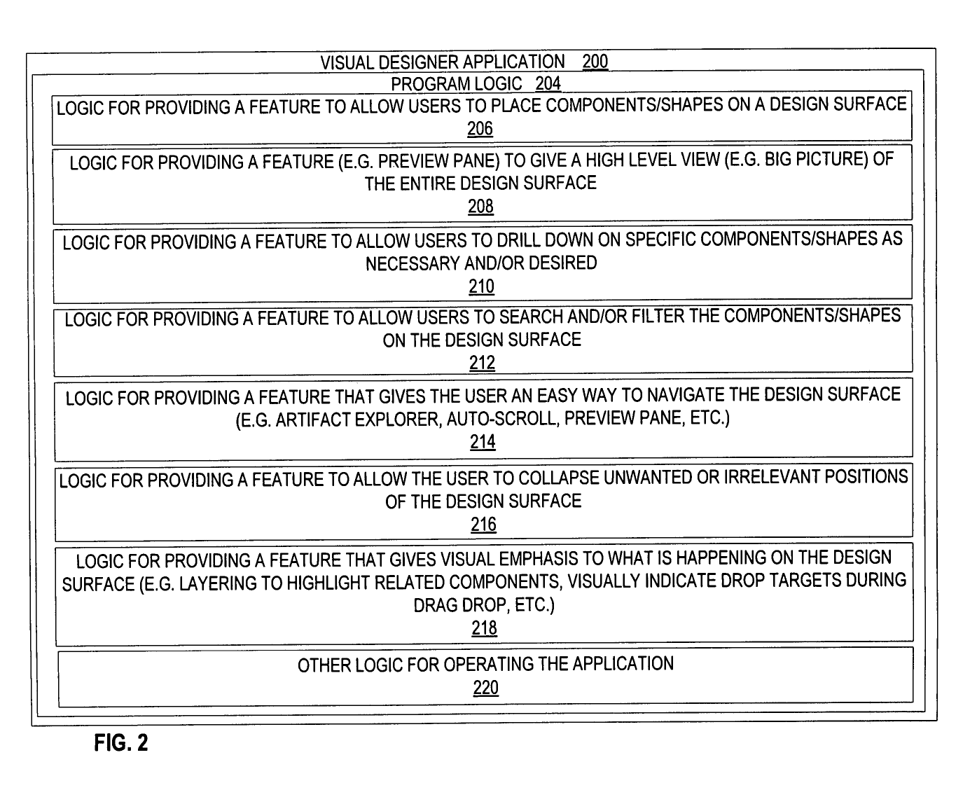

Computing device 100 includes one or more communication connections 114 that allow computing device 100 to communicate with other computers/applications 115. Device 100 may also have input device(s) 112 such as keyboard, mouse, pen, voice input device, touch input device, etc. Output device(s) 111 such as a display, speakers, printer, etc. may also be included. These devices are well known in the art and need not be discussed at length here. In one implementation, computing device 100 includes visual designer application 200. Visual designer application 200 will be described in further detail in FIG. 2.

Turning now to FIG. 2 with continued reference to FIG. 1, a visual designer application 200 operating on computing device 100 is illustrated. Visual designer application 200 is one of the application programs that reside on computing device 100. However, it will be understood that visual designer application 200 can alternatively or additionally be embodied as computer-executable instructions on one or more computers and/or in different variations than shown on FIG. 1. Alternatively or additionally, one or more parts of visual designer application 200 can be part of system memory 104, on other computers and/or applications 115, or other such variations as would occur to one in the computer software art.

Visual designer application 200 includes program logic 204, which is responsible for carrying out some or all of the techniques described herein. Program logic 204 includes logic for providing a feature to allow users to place components/shapes on a design surface 206; logic for providing a feature (e.g. a preview pane) to give a high level view (e.g. big picture) of the entire design surface 208; logic for providing a feature to allow users to drill down on specific components/shapes as necessary and/or desired 210; logic for providing a feature to allow users to search and/or filter the components/shapes on the design surface 212; logic for providing a feature that gives the user an easy way to navigate the design surface (e.g. artifact explorer, auto-scroll, preview pane, etc.) 214; logic for providing a feature to allow the user to collapse unwanted or irrelevant positions on the design surface 216; logic for providing a feature that gives visual emphasis to what is happening on the design surface (e.g. layering to highlight related components, visually indicate drop targets during drag drop, etc.) 218; and other logic for operating application 220. In one implementation, program logic 204 is operable to be called programmatically from another program, such as using a single call to a procedure in program logic 204.

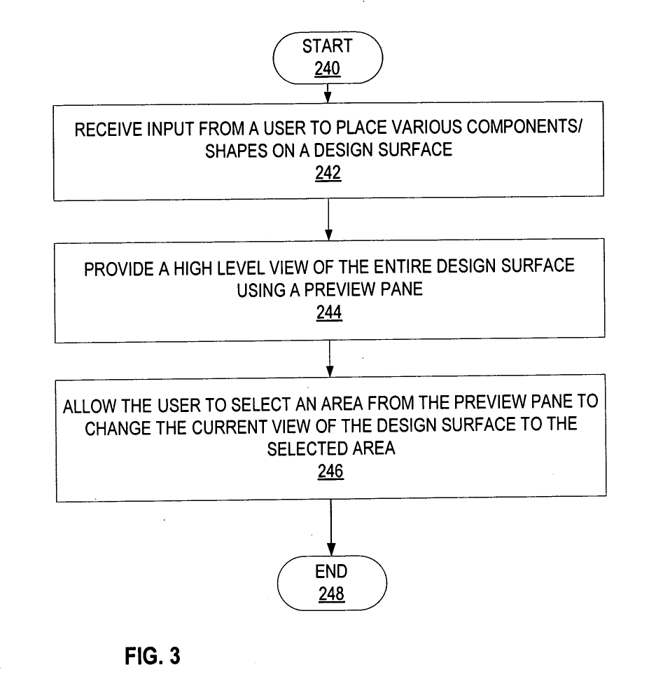

Turning now to FIGS. 3-11 with continued reference to FIGS. 1-2, the stages for implementing one or more implementations of visual designer application 200 are described in further detail. FIG. 3 is a high level process flow diagram for visual designer application 200. In one form, the process of FIG. 3 is at least partially implemented in the operating logic of computing device 100. The process begins at start point 240 with the system receiving input form a user to place various components/shapes onto a design surface (stage 242). A high level view of the entire design surface is provided to the user in a preview pane (stage 244). The system allows the user to select an area from the preview pane to change the current view of the design surface to the selected area (stage 246). The process ends at end point 248.

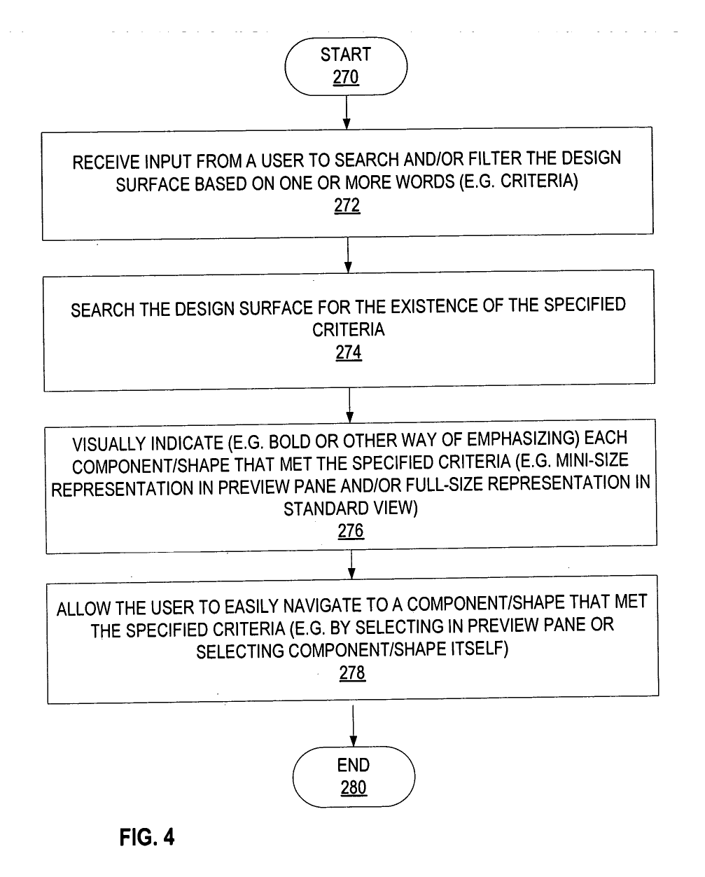

FIG. 4 illustrates one implementation of the stages involved in providing a search feature to easily locate certain components/shapes. In one form, the process of FIG. 4 is at least partially implemented in the operating logic of computing device 100. The process begins at start point 270 with the system receiving input from a user to search and/or filter the design surface based on one or more words (e.g. criteria) (stage 272). The system searches the design surface for the existence of the specified criteria (stage 274). The system visually indicates (e.g. in bold or some other way of emphasizing) each component/shape that met the specified criteria, such as in a mini-size representation in the preview pane and/or a full-size representation in the standard view (stage 276). The user can easily navigate to a component/shape that met the specified criteria, such as by selecting the component/shape in a preview pane or selecting the component/shape itself (stage 278). The process ends at end point 280.

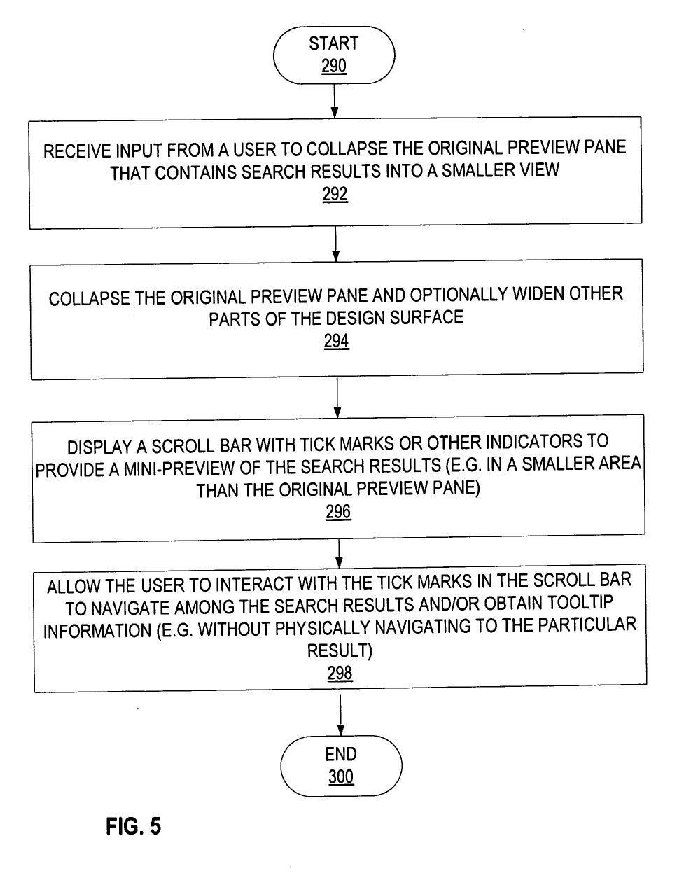

FIG. 5 illustrates one implementation of the stages involved in providing a collapsed preview pane to allow search results to be displayed in a smaller area. In one form, the process of FIG. 5 is at least partially implemented in the operating logic of computing device 100. The process begins at start point 290 with the system receiving input from a user to collapse the preview pane that contains search results into a smaller view (stage 292). The system collapses the preview pane and widens other parts of the design surface (stage 294). A scroll bar with tick marks or other indicators is displayed to provide a mini-preview of the search results (stage 296). The user is able to interact with the tick marks in the scroll bar area to navigate among the search results and/or obtain a tooltip of other information (e.g. without physically navigating to the particular result) (stage 298). The process ends at end point 300.

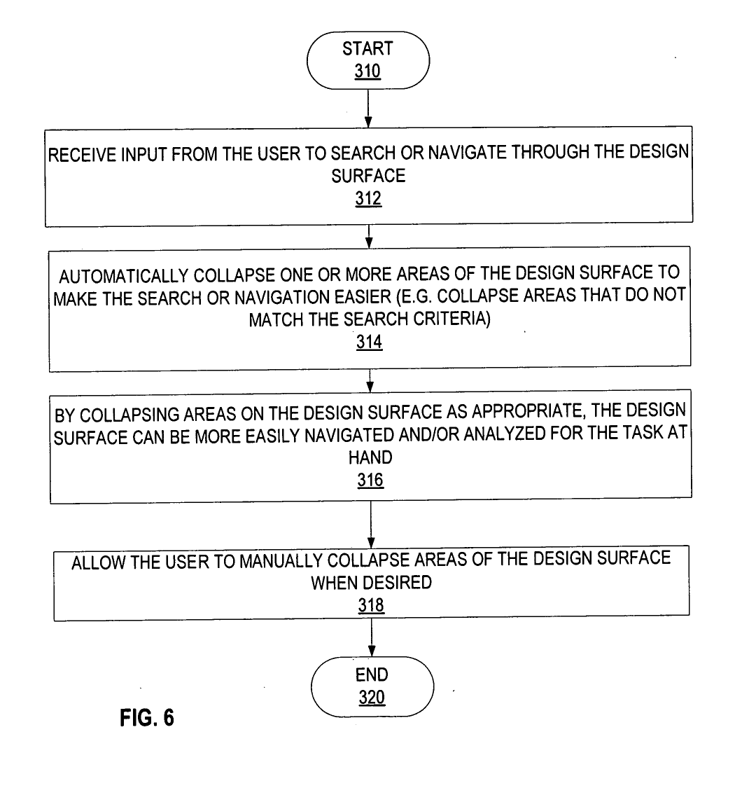

FIG. 6 illustrates one implementation of the stages involved in collapsing areas on the design surface. In one form, the process of FIG. 6 is at least partially implemented in the operating logic of computing device 100. The process begins at start point 310 with the system receiving input from the user to search or navigate through the design surface (stage 312). The system automatically collapses one or more areas on the design surface to make the search or navigation easier (stage 314). As one non-limiting example, areas are collapsed that do not match the search criteria. In one implementation, by collapsing areas on the design surface as appropriate, the design surface can be more easily navigated and/or analyzed for the task at hand (stage 316). The user can manually collapse areas of the design surface when desired (stage 318). The process ends at end point 320.

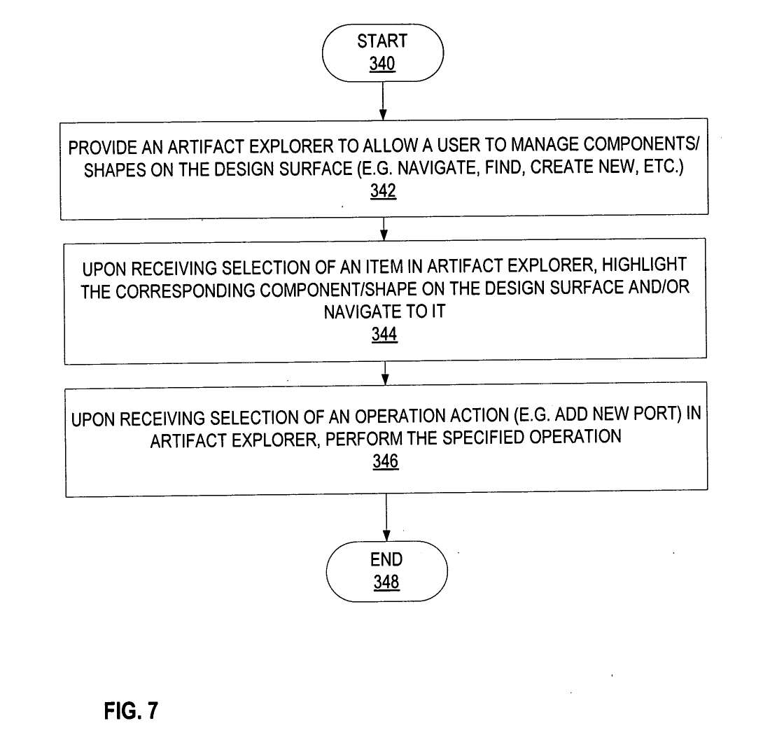

FIG. 7 illustrates one implementation of the stages involved in using an artifact explorer area to manage components/shapes on the design surface. In one form, the process of FIG. 7 is at least partially implemented in the operating logic of computing device 100. The process begins at start point 340 with the system providing an artifact explorer to allow a user to manage components/shapes on the design surface (stage 342). As a few non-limiting examples, the user could use the artifact explorer area to navigate, find, and/or create new components/shapes. Upon receiving selection of an item using the artifact explorer, the system highlights the corresponding component/shape on the design surface and/or navigates to it as appropriate (stage 344). Upon receiving selection of an operation action (e.g. add new port) in artifact explorer, the system performs the specified operation (stage 346). The process ends at end point 348.

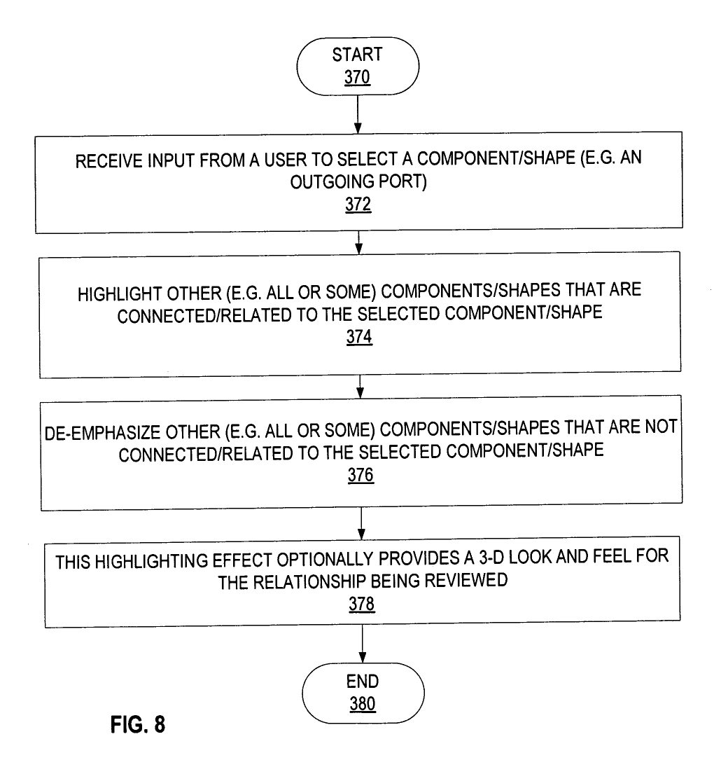

FIG. 8 illustrates one implementation of the stages involved in highlighting selected relationships on the design surface. In one form, the process of FIG. 8 is at least partially implemented in the operating logic of computing device 100. The process begins at start point 370 with the system receiving input from a user to select a component/shape (e.g. an outgoing port) (stage 372). The system highlights other (e.g. all or some) components/shapes that are connected and/or related to the selected component/shape (stage 374). The system de-emphasizes other (e.g. all or some) components/shapes that are not connected and/or related to the selected component/shape (stage 376). In one implementation, this highlighting effect optionally provides a 3-D look and feel for the relationship being reviewed (stage 38). The process ends at end point 380.

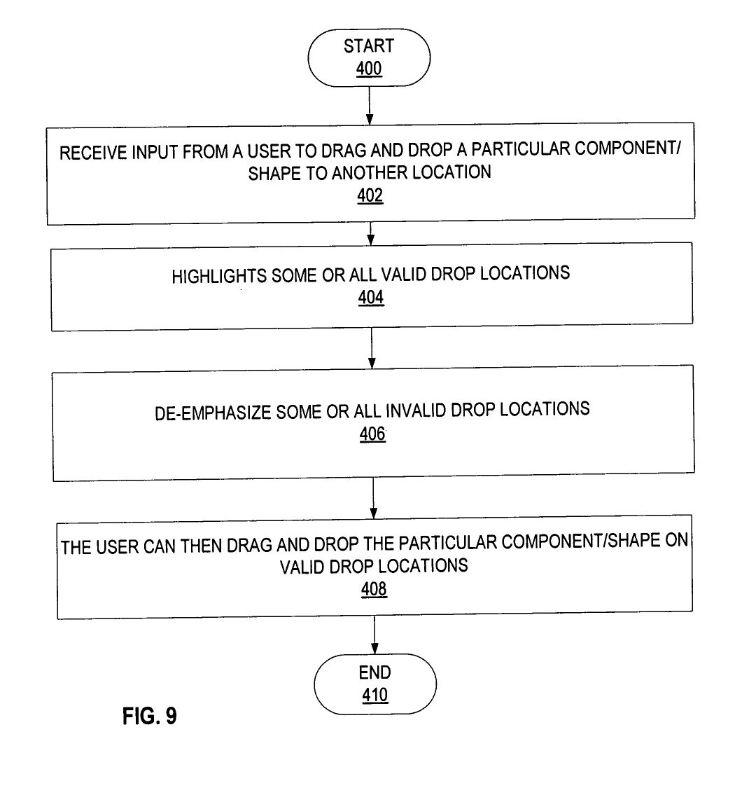

FIG. 9 illustrates one implementation of the stages involved in highlighting areas for drag drop operations. In one form, the process of FIG. 9 is at least partially implemented in the operating logic of computing device 100. The process begins at start point 400 with the system receiving input from a user to drag and drop a particular component/shape to another location (stage 402). The system highlights some or all valid drop locations (stage 404). The system de-emphasizes some or all invalid drop locations (stage 406). The user can then drag and drop the particular component/shape on a valid drop location (stage 408). The process ends at end point 410.

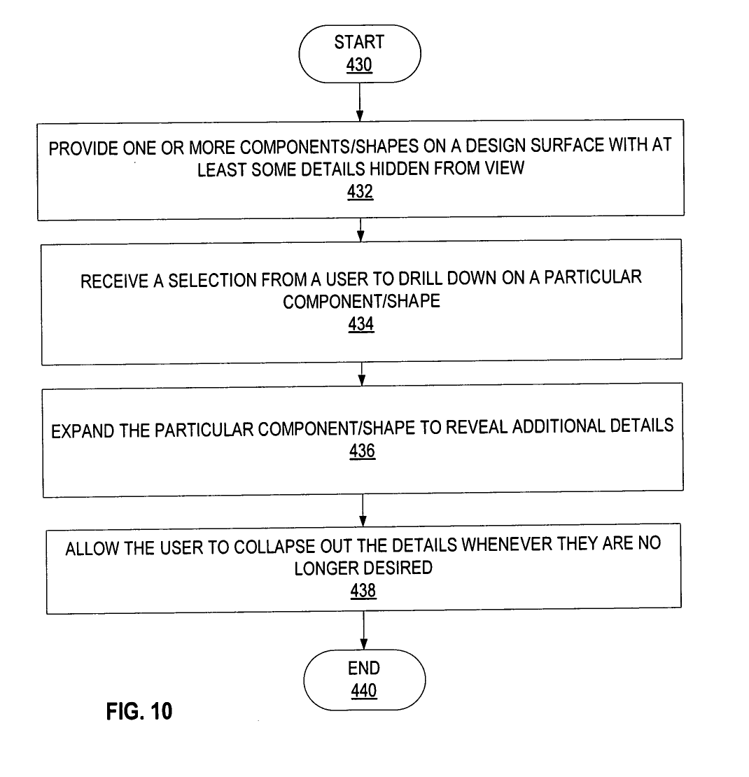

FIG. 10 illustrates one implementation of the stages involved in drilling down on a particular component/shape. In one form, the process of FIG. 10 is at least partially implemented in the operating logic of computing device 100. The process begins at start point 430 with the system providing one or more components/shapes on a design surface with at least some details hidden from view (stage 432). Upon receiving a selection from a user to drill down on a particular component/shape (stage 434), the system expands the particular component/shape to reveal additional details (stage 436). The user can collapse out the details whenever those details are no longer desired (stage 438). The process ends at end point 440.

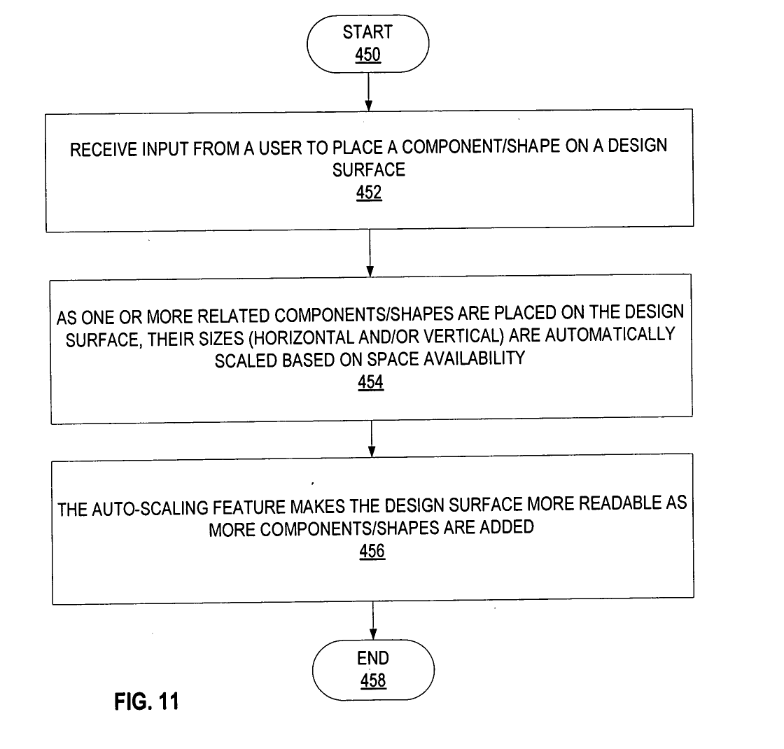

FIG. 11 illustrates one implementation of the stages involved in automatically scaling components/shapes on a design surface. In one form, the process of FIG. 11 is at least partially implemented in the operating logic of computing device 100. The process begins at start point 450 with the system receiving input from a user to place a component/shape on a design surface (stage 452). As one or more related components/shapes are placed on the design surface, their sizes (horizontal and/or vertical) are automatically scaled based on space availability (stage 454). In one implementation, the auto-scaling feature makes the design surface more readable as more components/shapes are added (stage 456). The process ends at end point 458.

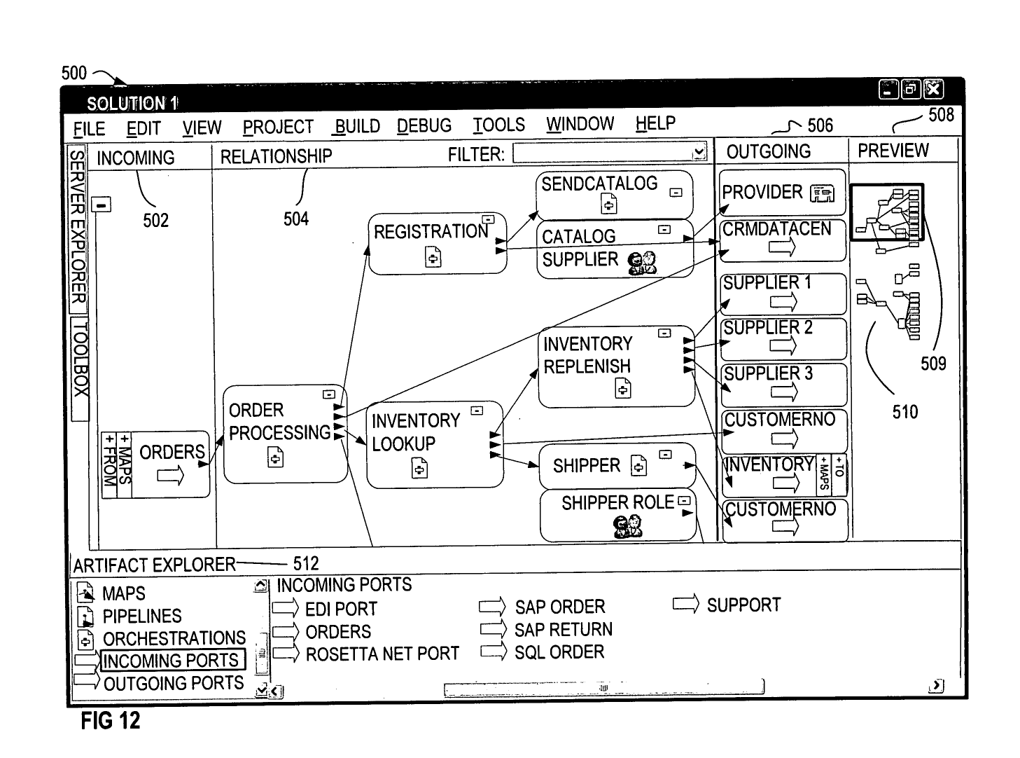

Turning now to FIGS. 12-20, simulated screens are shown to illustrate using visual designer application 200 to carry out one or more of the technologies and techniques of the system of FIG. 1 as described in FIG. 3-11. These screens can be displayed to users on output device(s) 111. Furthermore, these screens can receive input from users from input device(s) 112.

FIG. 12 is a simulated screen 500 for one implementation of the system of FIG. 1 that illustrates an overview of a visual designer with parts of a large-scale diagram displayed. Simulated screen 500 includes an incoming port area 502, a relationship area 504, an outgoing port area 506, and a preview pane 508. These are non-limiting examples of the types of areas that can be included on simulated screen 500. Other variations that include fewer or additional areas could also be used alternatively or additionally to these. Preview pane 508 includes a selected area 509 that illustrates a preview of what is currently on the screen. And other preview areas 510 for items that are not currently displayed on the screen. An artifact explorer area 512 is displayed to allow a user to perform one or more operations as described in further detail herein.

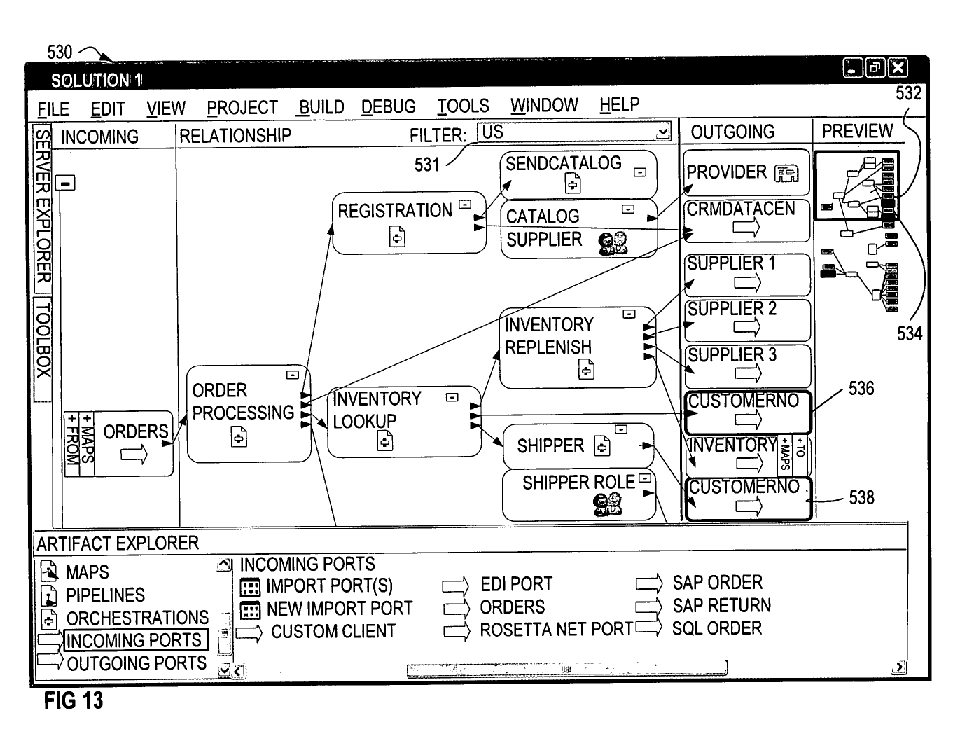

Turning now to FIG. 13, a simulated screen 530 for one implementation of the system of FIG. 1 and the stages of FIG. 4 is shown that illustrates a search technique with a preview window. When the user types a search/filter criteria in filter region 531 (stage 272 on FIG. 4), the system searches the design surface for the existence of the specified criteria with one or more of the components/shapes (stage 274). Visual indicators 532 and 534 are shown in the preview pane, and corresponding visual indicators 536 and 538 are shown in the standard pane (stage 278). The visual indicators 532 and 534 in the preview pane are small graphical representations of the positions of the components/shapes that met the specified criteria. This allows the user to view the preview pane and graphically see which components/shapes met the specified criteria in one or more parts of the drawing, and then navigate to one or more of those areas as desired (stage 278). The visual indicators 536 and 538 in the standard pane allow the user to see in the current view those components/shapes that met the specified search criteria.

In one implementation, a visual indicator can include a bold emphasis around an outer edge of a component/shape, a bolding of an entire component/shape, a particular color used for a component/shape, or other ways of emphasizing a component/shape that meets specified search criteria.

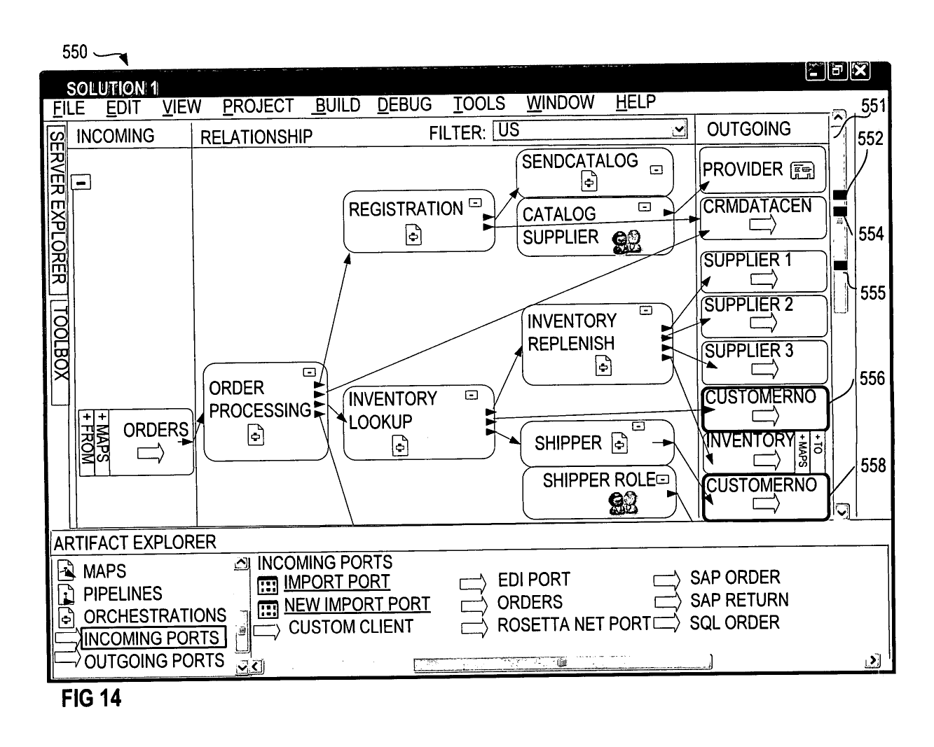

FIG. 14 is a simulated screen 550 for one implementation of the system of FIG. 1 and the stages of FIG. 5 that illustrates a search technique with a mini-preview window. Upon receiving input from a user to collapse the preview pane that contains the search results into a smaller view (stage 292 on FIG. 5), the system collapses the preview pane (stage 294) and displays a scroll bar 551 with tick marks (552, 554, and 555, respectively) or other indicators to provide a mini-preview of the search results (stage 296). The user can interact with the tick marks (552, 554, and/or 555) in the scroll bar 551 to navigate among the search results and/or can view a tooltip containing information about the particular component/shape without physically navigating to the particular result (stage 298). As with the simulated screen of FIG. 13, the current components/shapes in the design surface that match the specified search criteria are also visually emphasized (556 and 558), as are the areas in the preview pane.

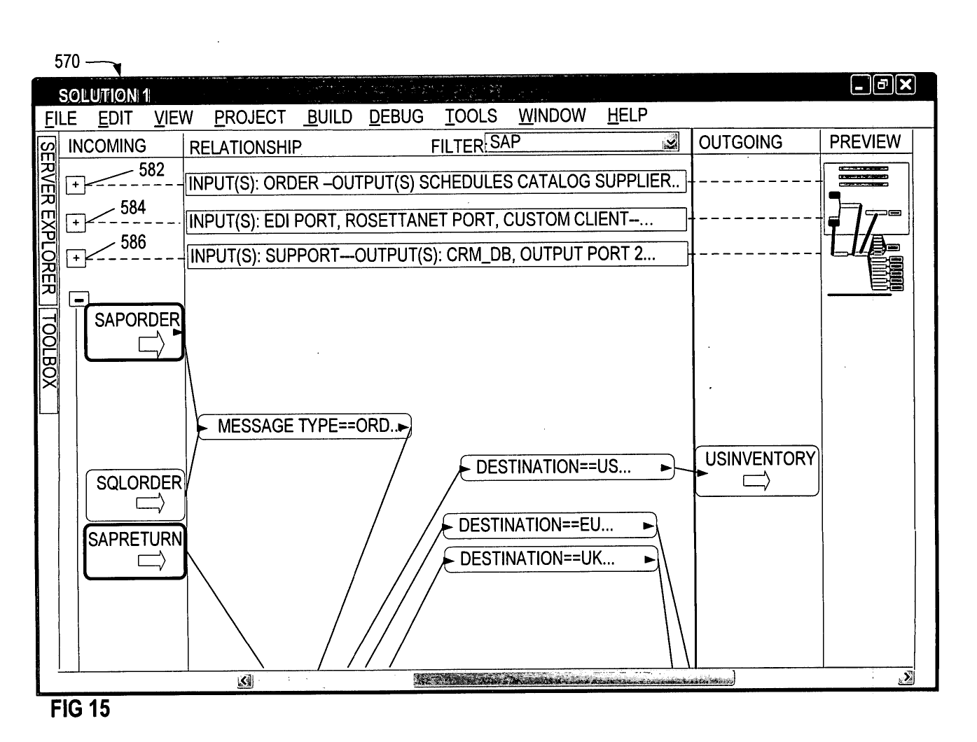

Turning now to FIG. 15, a simulated screen 570 for one implementation of the system of FIG. 1 and the stages of FIG. 6 is shown that illustrates a search technique with collapsed relationship sets. Upon receiving input from the user to search or navigate through the design surface (stage 312 on FIG. 6), the system automatically collapses one or more areas (582, 584, and 586) of the design surface to make the search or navigation easier (stage 314). By collapsing areas on the design surface as appropriate, the design surface can be more easily navigated and/or analyzed for the task at hand (stage 316). Alternatively or additionally, the user can manually collapse areas of the design surface when desired (stage 318).

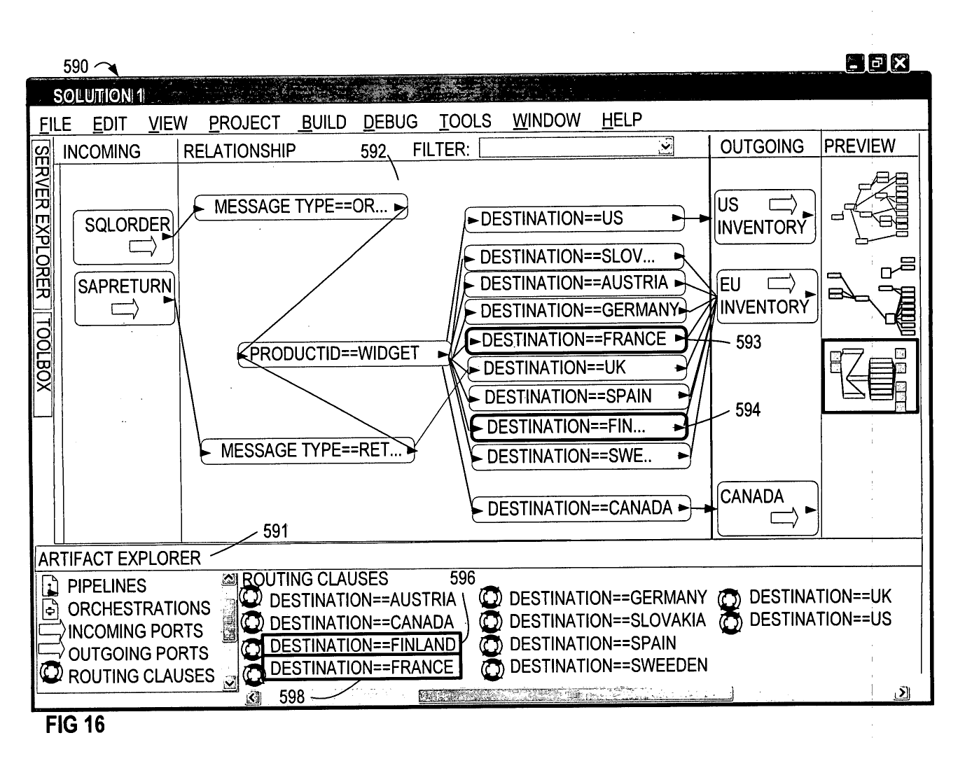

FIG. 16 is a simulated screen 590 for one implementation of the system of FIG. 1 and the stages of FIG. 7 that illustrates an interaction between an artifact explorer area 591 and a main drawing surface 592. The artifact explorer area 591 allows a user to manage components/shapes on the design surface 592 (stage 342 on FIG. 7). Upon receiving selection of an item in artifact explorer, such as items 596 and 598, the corresponding components/shapes (592 and 594) are highlighted (stage 344). In other implementations, such as when the user selects an option from the artifact explorer area 591 to perform an operation such as “create a new port”, the system perform the specified action (stage 346).

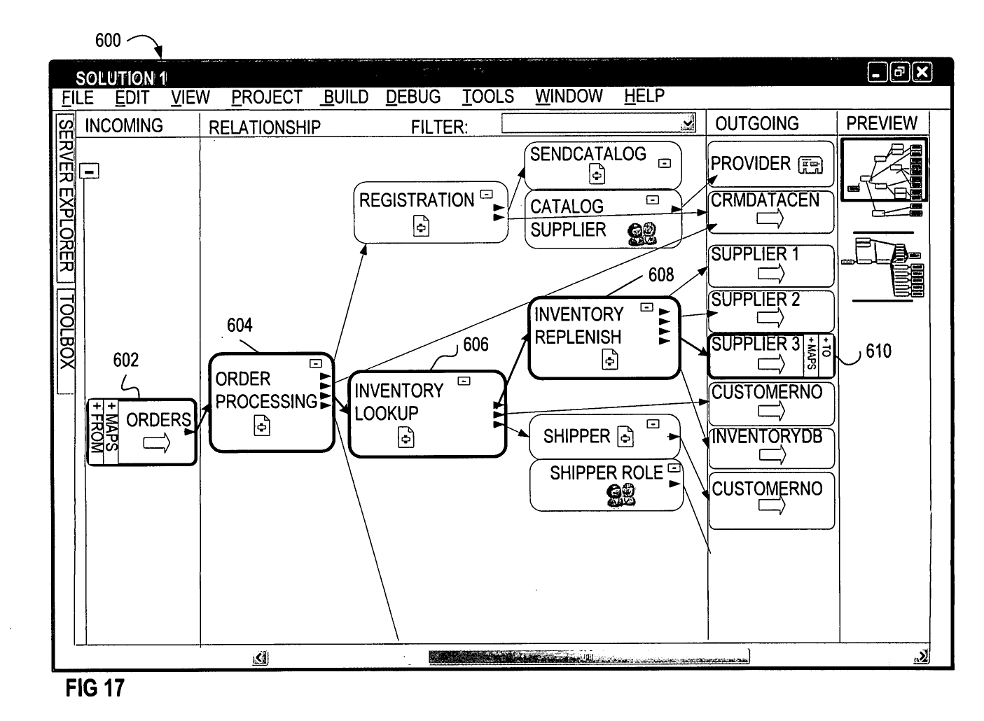

FIG. 17 is a simulated screen 600 for one implementation of the system of FIG. 1 and stages of FIG. 8 that illustrates highlighting related components/shapes. Upon receiving input from a user to select a component/shape (stage 372 in FIG. 8), such as outgoing port 610, the system highlights a relationship chain to show all components/shapes that are related to the selected component/shape (stage 374). Thus, components 602, 604, 606, 608, and 610 are highlighted in simulated screen 600 to show the relationship set correlating to the originally selected shape 610. The system also de-emphasizes other components that are not connected or otherwise related to the selected component (stage 376). In one implementation, this highlighting effect provides a 3-D look and feel for the relationship being reviewed (stage 378).

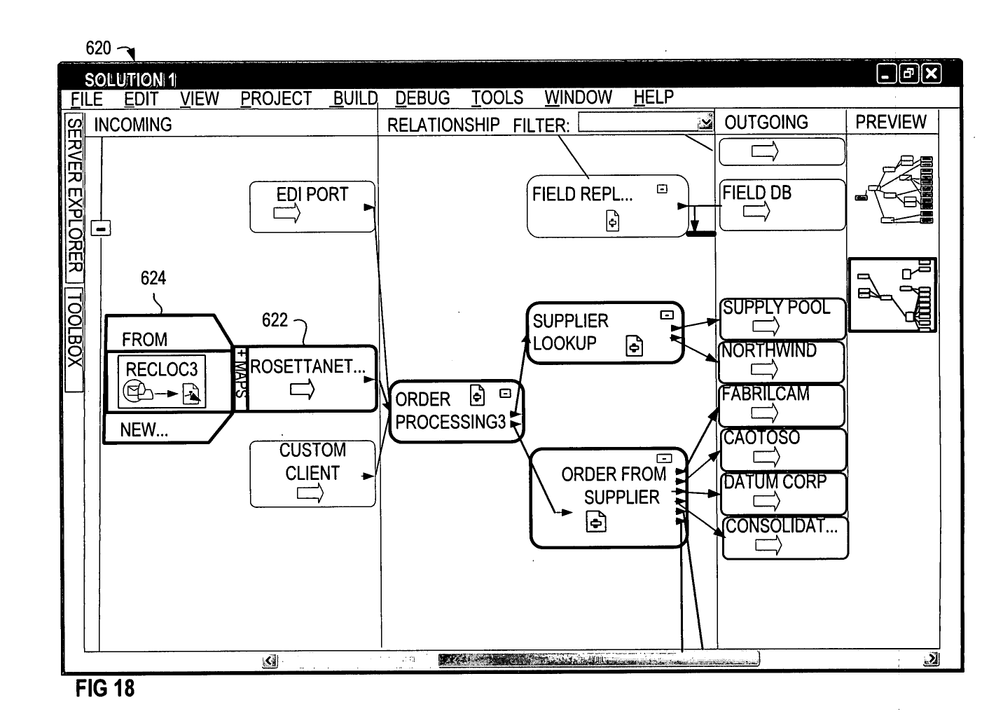

Turning now to FIG. 18, is a simulated screen 620 for one implementation of the system of FIG. 1 and the stages of FIG. 10 is shown that illustrates drilling down on a shape/component. One or more components are provided on a design surface with at least some details hidden from view (stage 432 on FIG. 10). Upon receiving a selection from a user to drill down on a particular component/shape (stage 432), such as component 622, the component is expanded to reveal additional details, such as details 624 (stage 436). The user can collapse the details 624 when they are no longer desired (stage 438).

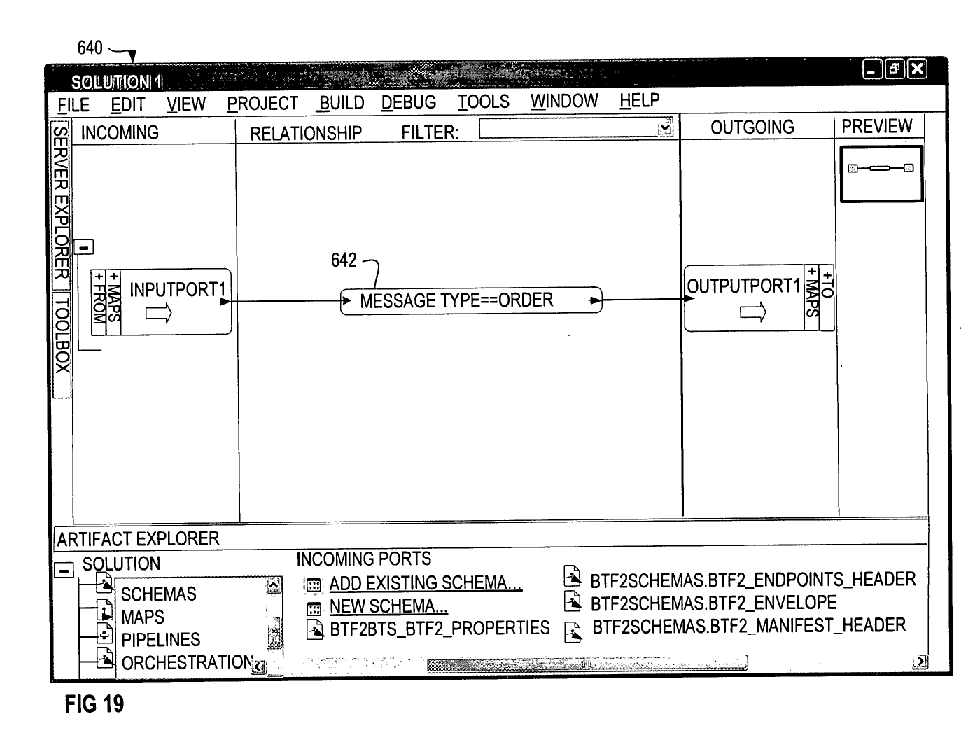

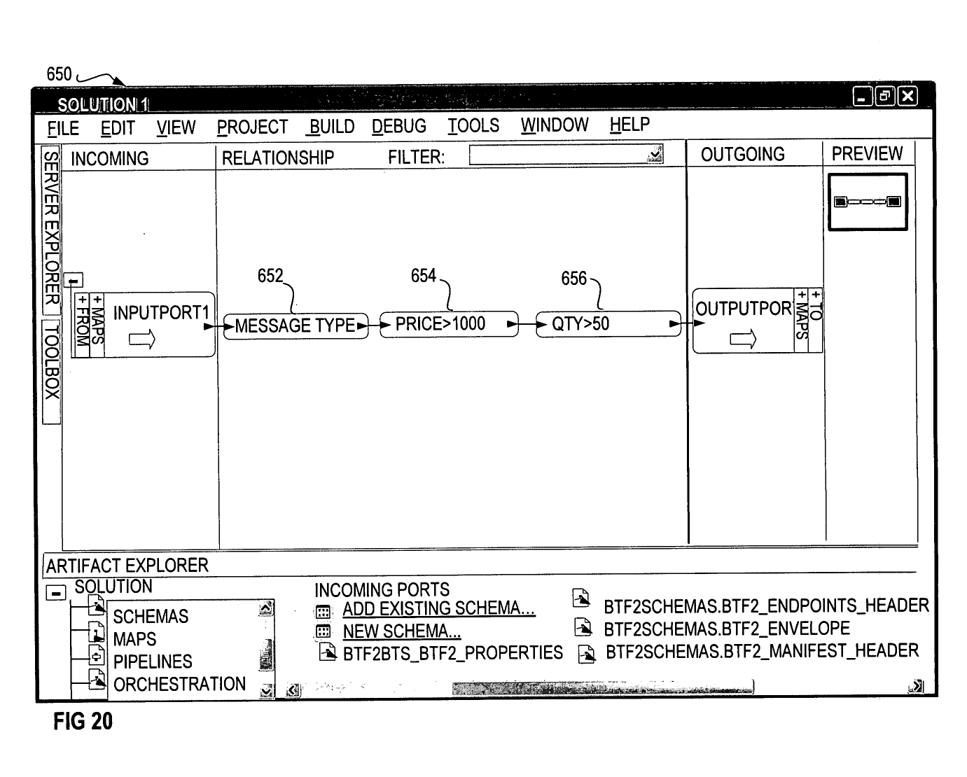

Turning now to FIGS. 19 and 20, simulated screens 640 and 650 for one implementation of the system of FIG. 1 and the stages of FIG. 11 are shown to illustrate an auto-scaling feature after one or more shapes/components are added to a design surface. As shown in simulated screen 640 of FIG. 19, the system received input from a user to place a component/shape 642 on the design surface (stage 452 on FIG. 11). As shown in simulated screen 650 of FIG. 20, as the user added additional shapes 654 and 656, the original shape 652 was reduced in size, and the other sizes for shapes 654 and 656 were scaled so they fit appropriately based on space availability (stage 454). In one implementation, the auto-scaling feature makes the design surface more readable as more components/shapes are added (stage 456).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. All equivalents, changes, and modifications that come within the spirit of the implementations as described herein and/or by the following claims are desired to be protected.

For example, a person of ordinary skill in the computer software art will recognize that the client and/or server arrangements, user interface screen content, and/or data layouts as described in the examples discussed herein could be organized differently on one or more computers to include fewer or additional options or features than as portrayed in the examples.

What is claimed is:

1. A method for searching components on a design surface comprising the steps of:
receiving a selection from a user to perform a search based on at least one search criteria;
searching a plurality of components on a design surface to determine if one or more of the components meet the search criteria; and
visually indicating in a preview pane a representation of the one or more components on the design surface that meet the search criteria.

2. The method of claim 1, further comprising:
visually indicating in a standard view of the design surface the actual one or more components that meet the search criteria.

3. The method of claim 1, further comprising:
receiving input from the user to select an area in the preview pane in order to navigate to a particular corresponding area.

4. The method of claim 3, further comprising:
navigating to the particular corresponding area in the design surface.

5. The method of claim 3, wherein the preview pane includes a mini-size representation of the components on the design surface.

6. The method of claim 1, wherein the preview pane allows the user to quickly navigate among the actual one or more components on the design surface that meet the search criteria.

7. The method of claim 1, wherein the one or more components that meet the search criteria are visually indicated using an emphasis technique.

8. The method of claim 1, wherein the emphasis technique includes a bolding effect.

9. A computer-readable medium having computer-executable instructions for causing a computer to perform the steps recited in claim 1.

10. A computer-readable medium having computer-executable instructions for causing a computer to perform steps comprising:
provide a preview pane that is operable to provide a user with a high level view of a plurality of components on a design surface;
provide a search feature that is operable to receive a search criteria from the user and execute the search against the plurality of components based on the specified search criteria; and
provide a navigation feature that is operable to allow the user to navigate the design surface.

11. The computer-readable medium of claim 10, further having computer-executable instructions for causing a computer to perform the step comprising:
provide a drill down feature that is operable to allow the user to drill down on a specific component of the plurality of components to see additional details regarding the specific component.

12. The computer-readable medium of claim 10, further having computer-executable instructions for causing a computer to perform the step comprising:
provide a collapse feature that is operable to allow the user to collapse at least one portion of the design surface.

13. The computer-readable medium of claim 10, further having computer-executable instructions for causing a computer to perform the step comprising:
provide a layering feature that is operable to visually highlight related components on the design surface.

14. The computer-readable medium of claim 10, further having computer-executable instructions for causing a computer to perform the step comprising:
provide a drag drop feature that is operable to visually indicate an appropriate drop target during a drag drop operation.

15. The computer-readable medium of claim 10, wherein the navigation feature is operable to allow the user to navigate the design surface by using an artifact explorer.

16. The computer-readable medium of claim 10, wherein the navigation feature is operable to allow the user to navigate the design surface by using an auto-scroll technique.

17. The computer-readable medium of claim 10, wherein the navigation feature is operable to allow the user to navigate the design surface upon selecting an area in the preview pane.

18. A method for collapsing a preview pane into a smaller view comprising the steps of:
receiving input from a user to collapse an original preview pane that contains a search result;
collapsing the original preview pane; and
displaying a scroll bar with at least one indicator to provide a mini-preview of the search result in a smaller area than the original preview pane.

19. The method of claim 18, wherein the at least one indicator is a tick mark.

20. A computer-readable medium having computer-executable instructions for causing a computer to perform the steps recited in claim 18.
